(19) United States
(12) Patent Application Publication
(10) Pub. No.: US 2008/0091735 A1
(43) Pub. Date: Apr. 17, 2008

(54) DOCUMENT MANAGEMENT SYSTEM

(75) Inventors: Takayuki FUKUSHIMA, Tochigi (JP); Koichi NAGOSHI, Tokyo (JP); Takeshi OOTSUKA, Kanagawa (JP); Ikuo YOSHIDA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/866,598

(22) Filed: Oct. 3, 2007

(30) Foreign Application Priority Data
Oct. 16, 2006 (JP) 2006-281510

(51) Int. Cl. G06F 17/30

(52) U.S. Cl. 707/200; 707/E17.001

(57) ABSTRACT

Relevant document data are retrieved from a document management server that stores document data in accordance with a user operation at a document management client. A content of the document data is shown to the user at the document management client so that the user can provide an instruction whether to execute an alteration prevention by an operation of the user. When an instruction to execute an alteration prevention is provided, alteration prevention processing is executed at the document management server.

### BACKGROUND OF THE INVENTION

1. Field of the Invention

The present invention relates to a document management system that manages a document by digitizing it.

2. Description of Related Art

In recent years, with the implementation of e-Document Law in Japan, digitizing a document that was required to save in paper heretofore has become acceptable. Therefore, it is desired to provide authentication that officially certifies electronic document data to be managed is free from alteration and is authentic, in a document management system that stores and consolidates a number of digitized documents.

As for a technology to authenticate such electronic document data, a method is conventionally known that stores image data, which are generated by scanning an original document, after adding management information including its preparer, date and time of creation and the like as a digital watermark (refer to Related Art 1). In addition, another method is known that stores electronic document data along with a time stamp issued by a time authentication server after an original document is scanned (refer to Related Art 2).

| | |
|---|---|
| [Related Art 1] | Japanese Patent Laid Open Publication 2002-94770 |
| | (FIGS. 1 & 2) |
| [Related Art 2] | Japanese Patent Laid Open Publication 2005-123980 |
| | (FIGS. 1 & 4) |

Electronic document data stored and managed by such a document management system, however, includes electronic document data that do not require an alteration prevention such as a document with low importance, and a document that is subject to require editing. Furthermore, there is no need to prevent alteration on electronic document data that should be eliminated due to a flaw such as a missing page, a double scan and the like.

However, the conventional technology uniformly performs an alteration prevention by registering a document to a document management system. Therefore, when a paid service by a third party is used, it creates unnecessarily increased expenses caused by the alteration prevention processing for electronic document data that are not in need of the alteration prevention or that include a flaw.

### SUMMARY OF THE INVENTION

The present invention is provided to address the above-described problem of the conventional technology. A main purpose of the invention is to provide a document management system that is configured to avoid unnecessarily increased expenses caused by alteration prevention processing for electronic document data that are not in need of an alteration prevention or that includes a flaw.

A document management system according to the present invention includes: a memory that stores document data; a document retriever that retrieves the document data from said memory; a processor that executes alteration prevention processing for the document data; document confirmer that displays the document data retrieved by said document retriever, and issues an instruction whether to execute the alteration prevention processing; and a controller that causes said processor to execute the alteration prevention processing when said document confirmer issues the instruction to execute the alteration prevention processing.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a system configuration diagram illustrating a document management system according to the present invention;

FIG. 2 is a block diagram illustrating a schematic configuration of a document management server of FIG. 1;

FIG. 3 is a block diagram illustrating a schematic configuration of a multifunction apparatus of FIG. 1;

FIG. 4 is a block diagram illustrating a schematic configuration of a document management client of FIG. 1;

FIG. 5 illustrates a registration content of a document management database of the document management server of FIG. 2;

FIG. 6 illustrates a menu screen displayed on an operation panel of the multifunction apparatus of FIG. 3;

FIG. 7 illustrates a document retrieval screen displayed on a CRT of the document management client of FIG. 4;

FIG. 8 illustrates a document retrieval screen displayed on a CRT of the document management client of FIG. 4;

FIG. 9 is a flow chart illustrating a document registration procedure performed at the multifunction apparatus and the document management server of FIG. 1;

FIG. 10 is a flow chart illustrating a document confirmation and alteration prevention processing procedure performed at the document management client and the document management server of FIG. 1; and

FIG. 11 is a block diagram illustrating another example of a document management system according to the present invention.

### DETAILED DESCRIPTION OF PREFERRED EMBODIMENTS

In a first aspect of the present invention, a document management system includes: a data storage that stores electronic document data; an alteration prevention processor that executes alteration prevention processing of the electronic document data; a document retriever that retrieves relevant electronic document data from the data storage according to an operation of a user; a document confirmer that shows a user a content of the electronic document data obtained by the document retriever, and allows an operation of the user to instruct whether to execute an alteration prevention; and a controller that causes the alteration prevention processor to execute alteration prevention processing when there is an instruction to execute an alteration prevention by the document confirmer.

Accordingly, a user can select electronic document data to perform an alteration prevention appropriately based on the needs of an alteration prevention, and execute alteration prevention processing after confirming that the electronic document data are free from a flaw. Therefore, it is possible to prevent unnecessarily increased expenses caused by the alteration prevention processing for electronic document data that are not in need of the alteration prevention or electronic document data that include a flaw.

Further, the alteration prevention processing is performed after confirming that the electronic document data are free from a flaw, and the electronic document data that include a flaw are eliminated before the data are finally stored by a data storage. Therefore, the electronic document data can be securely stored without a flaw.

In a second aspect of the present invention, the document management system according to the first aspect further includes: a management information register that registers, corresponding to the electronic document data, individual identification information of a user who has electronic document data processing authorization; and a user authenticator that obtains individual identification information from the user. The document retriever refers to the management information register based on the individual identification information obtained by the user authenticator, and retrieves electronic document data for which the user has the processing authorization.

Accordingly, the operating user provides an instruction for document confirmation and alteration prevention to only electronic document data for which the user has the processing authorization. Therefore, performing an unauthorized or unintended alteration prevention can be prevented.

In a third aspect of the present invention, the document management system according to the first aspect includes: the document confirmer that allows a user to instruct whether to execute an electronic signature and/or a time stamp, or perform neither, as alteration prevention processing performed by the alteration prevention processor.

Accordingly, an appropriate alteration prevention can be performed based on the document types and the like.

In such case, the electronic signature is generated by encrypting electronic document data or its digest data using a predetermined secret key (e.g., a secret key of an apparatus). The authenticity of the electronic document data can be verified by decrypting using a corresponding public key (e.g., a public key of an apparatus). The time stamp (time certificate) is generated by encrypting electronic document data or its digest data to include time information using a secret key (e.g., a secret key of a time authentication body). An unaltered date and time of creation can be obtained by decrypting using a corresponding public key (e.g., a public key of a time authentication body).

In a fourth aspect of the present invention, the document management system according to the first aspect includes: an alteration prevention designator that specifies whether to require an alteration prevention upon document registration through a user operation; and a management information register that registers information, for each document, whether to require an alteration prevention and whether the alteration prevention has been executed based on the specified information regarding alteration prevention obtained from the alteration prevention designator, and result information on alteration prevention processing performed by the alteration prevention processor; wherein the document retriever retrieves electronic document data that requires an alteration prevention but has not yet been processed for the alteration prevention based on the information registered by the management information register.

Accordingly, the user can confirm only a document that requires an alteration prevention but has not yet been processed. Therefore, a level of convenience is enhanced.

In a fifth aspect of the present invention, a document management system includes: a data storage that stores electronic document data; an alteration prevention processor that executes alteration prevention processing of electronic document data; an alteration prevention designator that specifies whether to require alteration prevention upon document registration through a user operation; and a controller that prevents the alteration prevention processor from executing alteration prevention processing when the alteration prevention designator specifies that alteration prevention is not needed.

Accordingly, a user can select electronic document data to perform an alteration prevention appropriately based on the needs of an alteration prevention. Therefore, it is possible to prevent unnecessarily increased expenses caused by the alteration prevention processing for electronic document data that are not in need of the alteration prevention.

In sixth aspect of the present invention, the document management system according to the fourth or fifth aspect includes: the alteration prevention designator that allows a user to specify whether to require an electronic signature and/or a time stamp, or not to require any, as alteration prevention processing performed by the alteration prevention processor.

Accordingly, an appropriate alteration prevention can be performed based on the document types and the like.

In a seventh aspect of the present invention, the document management system according to the first aspect, includes: a server apparatus and a client apparatus that are mutually connected to a network, wherein the server apparatus includes the data storage, alternation prevention processor, document retriever and controller; and the client apparatus includes the document confirmer.

Accordingly, a content of electronic document data can be confirmed by a client apparatus such as a personal computer including a display apparatus that excels at operability and allows a high-resolution display. Therefore, a level of convenience for a user is enhanced.

In the eighth aspect of the present invention, the document management system according to the first aspect includes: an image scanner that generates electronic document data through reading an image of document, wherein the image scanner includes the data storage, alteration prevention processor, document retriever, document confirmer and controller.

Accordingly, the document management system is solely configured with the image scanner, therefore, simplifying the system configuration can reduce the cost involved in document management.

In such case, the image scanner can be: for instance, a scanner apparatus that has an only image scanner function; a copier; a facsimile apparatus; or a multifunction apparatus that has an image reading function.

In a ninth aspect of the present invention, the document management system according to the first aspect includes a data writer that saves accumulated electronic document data in the data storage in an un-rewritable mass storage medium.

Accordingly, periodically saving electronic document data stored by data storage into a mass storage medium can prevent the electronic document data from being lost due to an equipment breakdown. Therefore, electronic document data can be safely saved for a long time. In particular, electronic document data stored in the mass storage medium are confirmed to be free from a flaw by document confirmer, therefore, wasting the mass storage medium can be avoided.

In such case, it is preferable that the data writer to be a DVD-R drive that performs writing processing to a DVD-R medium, which is a mass storage medium with high versatility.

The embodiment of the present invention is explained in the following, in reference to the above-described drawings.

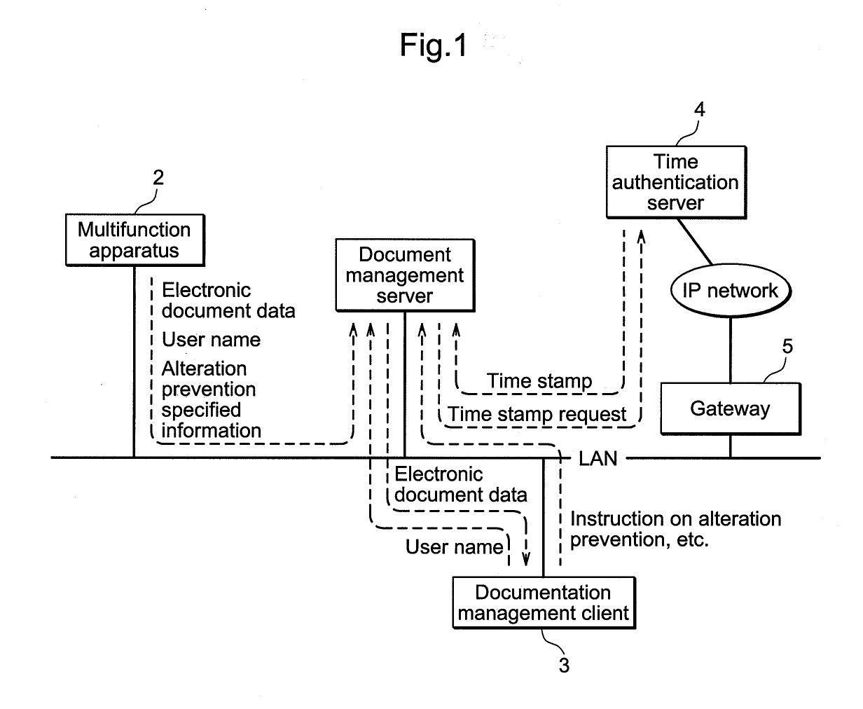

FIG. 1 illustrates a system configuration diagram of a document management system according to the present invention. The document management system includes: document management server 1 that stores a digitized document and manages the stored document in an integrated fashion; multifunction apparatus 2 that scans an original document by a scanner and registers the document with document management server 1; and document management client 3 that shows a document stored in document management server 1.

Document management server 1, multifunction apparatus 2 and document management client 3 are connected to each other via a LAN.

At document management server 1, in particular, electronic document data are stored under a condition where an alteration prevention is executed to prevent electronic document data from being revised intentionally or unintentionally while the electronic document data are stored for an extensive time, and processing of generating an electric signature and a time stamp as an alteration prevention processing is performed. Document management server 1 is connected to time authentication server 4 that issues a time stamp via a LAN, gateway 5 and an IP network.

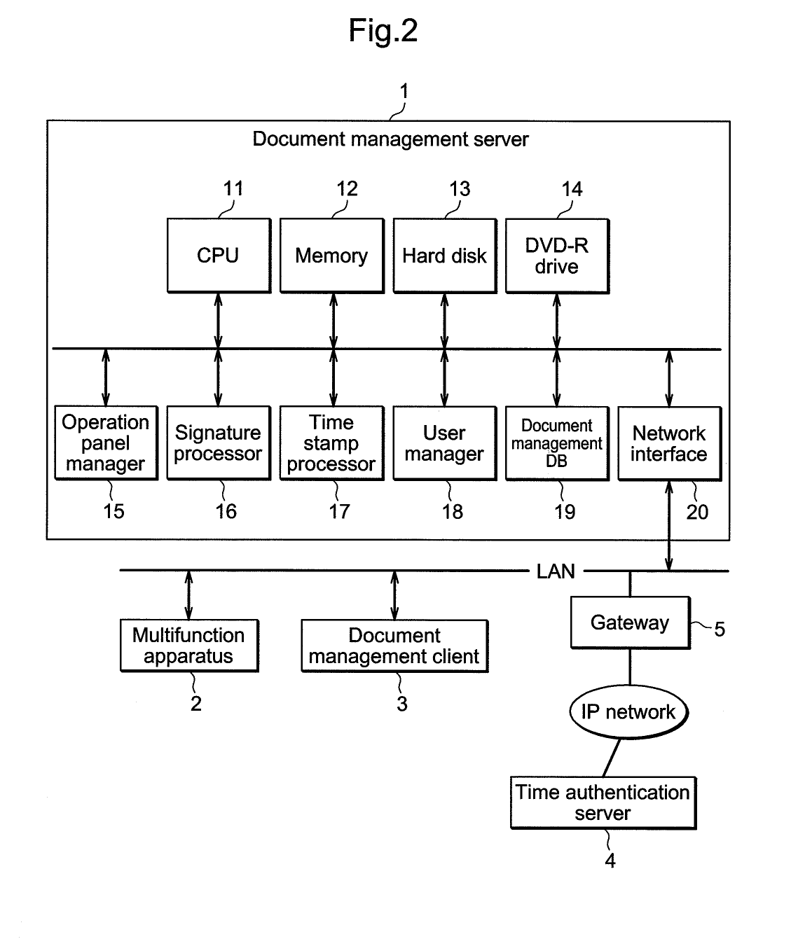

FIG. 2 is a block diagram illustrating a schematic configuration of document management server 1 of FIG. 1. Document management server 1 includes: CPU 11; memory 12; hard disk 13; DVD-R drive 14; operation panel manager 15; signature processor 16; time stamp processor 17; user manager 18; document management database 19; and network interface 20.

Hard disk 13 stores electronic document data obtained through scanning an original document at multifunction apparatus 2. When an alteration prevention of the electronic document data is executed, in particular, alteration prevention data regarding the electronic document data, in other words, an electronic signature and a time stamp, are also stored along with the electronic document data.

DVD-R drive 14 performs a writing processing on a DVD-R medium that is an un-rewritable mass storage medium. In case of an equipment breakdown, data stored in hard disk 13 are saved periodically including electronic document data and alteration prevention data of the electronic document data, in other words, an electronic signature and a time stamp.

Signature processor 16 generates an electronic signature, and the electronic signature is generated by encrypting digest data of electronic document data (e.g., a hash value obtained by a hash function) using a secret key held by document management server 1. In addition, with regard to generation of the electronic signature, an electronic certificate that proves its authenticity is prospectively issued by a certification authority, and its status of electronic document data alteration can be verified by decrypting the electronic signature using a public key retrieved from the electronic certificate.

Time stamp processor 17 requests to issue a time stamp to time authentication server 4 by transmitting digest data of electronic document data (e.g., a hash value of a hash function). Time authentication server 4 receives a time certificate from an un-illustrated time distribution center. A time stamp is generated by encrypting digest data obtained from document management server 1 including time information, using a secret key of time authentication server 4. An alteration free date and time of creation can be obtained by decrypting the time stamp using a public key of time authentication server 4.

User manager 18 manages user information such as a user name and a password, which are required for a user authentication in order to use multifunction apparatus 2 or to access document management server 1 from document management client 3. When a user authentication is performed at multifunction apparatus 2 and document management client 3, required user information for the user authentication is provided to multifunction apparatus 2 and document management client 3.

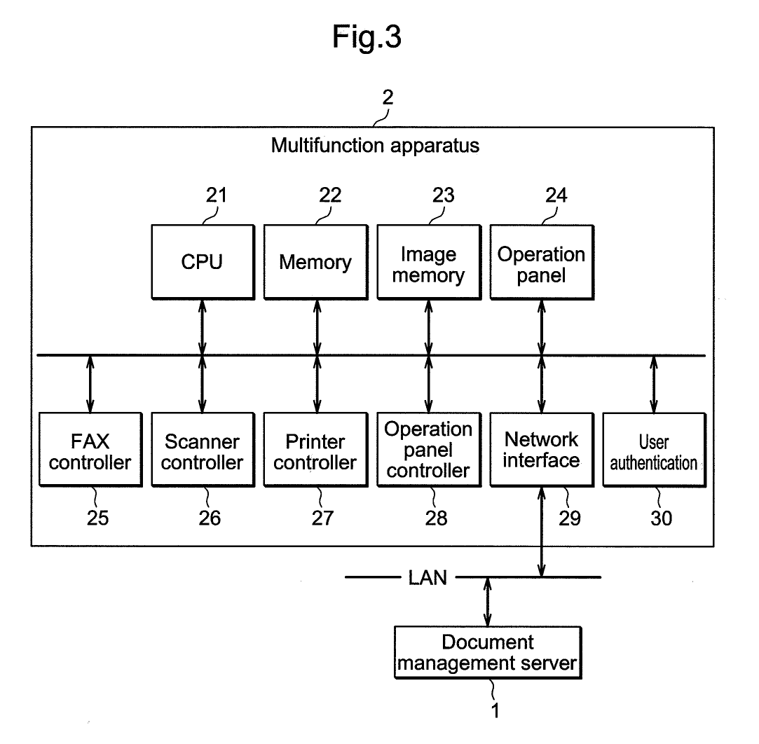

FIG. 3 is a block diagram illustrating a schematic configuration of multifunction apparatus 2 of FIG. 1. Multifunction apparatus 2 includes: CPU 21, memory 22; image memory 23; operation panel 24; facsimile controller 25; scanner controller 26; printer controller 27; operation panel controller 28; network interface 29; and user authenticator 30.

Multifunction apparatus 2 generates electronic document data, which stores image information generated by scanning an image of an original document optically, in a predetermined file format (e.g., TIFF, PDF, etc.). The electronic document data is transmitted to document management server 1 via network interface 29 and a LAN, and then is registered.

Further, multifunction apparatus 2 allows a user to specify whether an electronic signature and/or a time stamp is necessary, or neither is necessary, as an alteration prevention processing using operation panel 24, upon document registration when an image of an original document is scanned to register with document management sever 1. The specified information on an alteration prevention obtained by this is sent to document management server 1, and then is registered.

User authenticator 30 performs a user authentication that verifies whether an operating user has authorization to use multifunction apparatus 2. The user is requested to input a user name and a password using operation panel 24. When the entry matches with registered contents in user manager 18 of document management server 1, only then will a usage of multifunction apparatus 2 be granted.

In addition, when a user authentication at user authenticator 30 is successful, an obtained user name is registered with document management server 1 as a user with a document processing authorization.

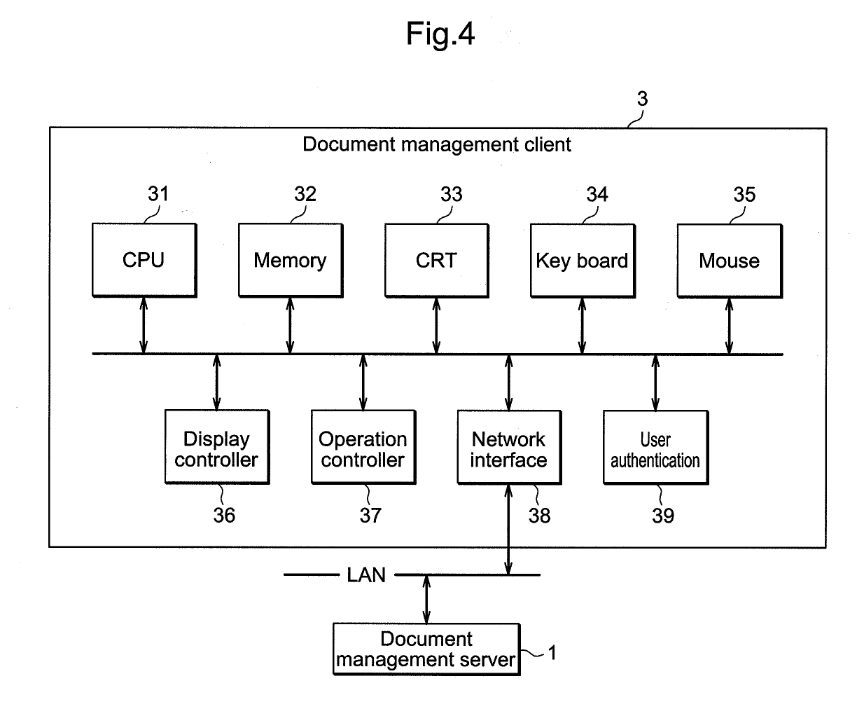

FIG. 4 is a block diagram illustrating a schematic configuration of document management client 3 of FIG. 1. Document management client 3 includes: CPU 31; memory 32; CRT 33; keyboard 34, mouse 35; display controller 36; operation controller 37; network interface 38; and user authenticator 39.

Document management client 3 obtains electronic document data registered with document management server 1 and causes CRT 33 to display a content of the electronic document data, to perform a document confirmation that allows a user to confirm whether electronic document data includes a flaw. At this time, as alteration prevention processing, document management client 3 allows a user to specify whether to execute an electronic signature and/or a time stamp, or execute neither. Accordingly, processing of generating an electronic signature and a time stamp is executed at document management server 1.

At the document confirmation, document database 19 of document management server 1 searches for an unprocessed document among electronic document data registered with document management sever 1, in other words, electronic document data for which alteration prevention processing is unexecuted even though it is specified for alteration processing upon document registration at multifunction apparatus 2, are searched. A content of the electronic document data is displayed on CRT 33 of document management client 3, therefore, a user can confirm an unprocessed document easily.

User authenticator 39 performs user authentication that verifies whether an operating user has authorization to access document management server 1. The user is requested to input a user name and a password using keyboard 34. When the entry matches with registered contents in user manager 18 of document management server 1, only then will access to the document management sever 1 be granted.

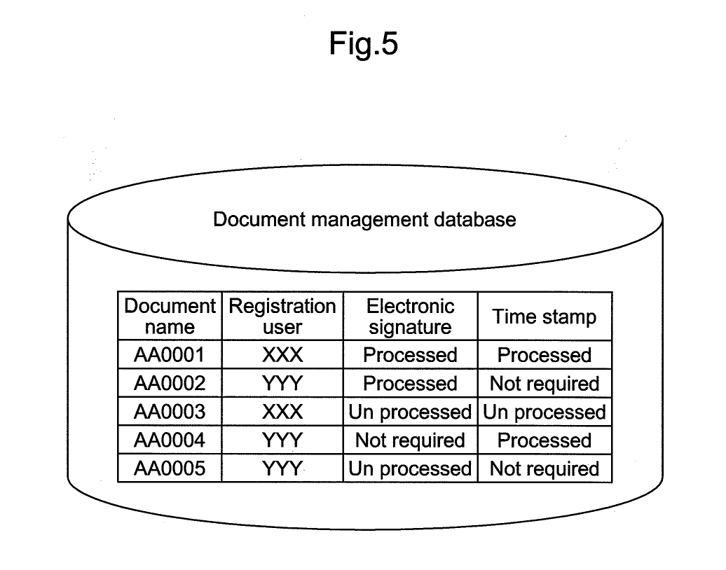

FIG. 5 illustrates a registration content of document management database 19 of document management server 1 of FIG. 2. Document management database 19 has a document management database, which searches for an unexecuted document, that is, a document for which an alteration prevention processing is unexecuted even though it is specified for alteration processing, based on the search instructions provided by document management client 3.

The document management database registers information on registered users, whether to require each processing of electronic signature and time stamp as an alteration prevention, and whether such processing is executed when these processing are required, corresponding to the document names.

The document name is electronic document data identification information saved in hard disk 13, such as a file name. The registered user is an identification name of a user who has processing authorization of a document, that is, a user name obtained from user authenticator 30 upon document registration with document management server 1 when multifunction apparatus 2 scans an original document.

Information with respect to an electric signature and a time stamp is according to the specified information regarding an alteration prevention obtained from a specifying operation upon document registration at multifunction apparatus 2, and the result information of alteration prevention processing executed in response to an alteration prevention instruction performed at document confirmation at document management client 3. When it is specified as no need upon document registration at multifunction apparatus 2, it is regarded as “unnecessary”. When it is specified as necessary upon registration but when processing has not yet been performed, it is regarded as “unprocessed”. When processing has already been performed, it is regarded as “processed”.

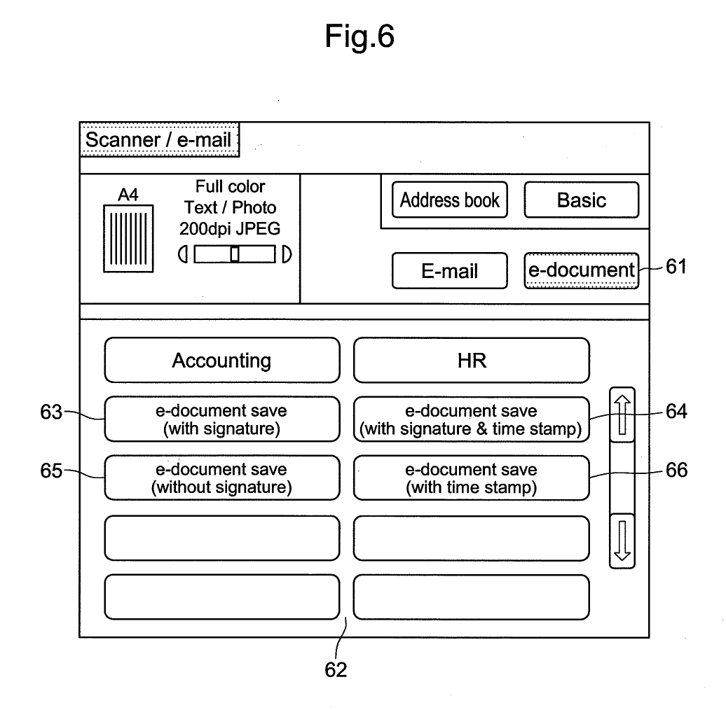

FIG. 6 illustrates a menu screen displayed on operation panel 24 of multifunction apparatus 2 of FIG. 3. The menu screen is displayed by selecting a scanner mode (a mode that scans an image of a document) by a required button operation on operation panel 24. In addition, a display of operation panel 24 of multifunction apparatus 2 is a touch panel display.

On the menu screen, by operating button 61 of “e-document”, a button to select a job regarding “e-document save” that registers a scanned document with document management server 1 is displayed on display selector 62. These jobs are predetermined by a user.

Here, the buttons 63 through 66 to select each job are displayed: “e-document save (with signature)” that executes only an electronic signature as an alternation prevention; “e-document save (with signature & time stamp)” that executes both an electronic signature and a time stamp as an alteration prevention; and “e-document save (with time stamp)” that executes only a time stamp as an alteration prevention.

After a user operates necessary buttons 63 through 66, and when an un-illustrated start button on operation panel 24 is operated, an operation of scanning an image of a document begins and electronic document data are generated. Further, according to an operated button 63 through 66, specified information regarding an alteration prevention, in other words, whether to require an electronic signature and/or a time stamp, or neither is required, is generated. The specified information on the alteration prevention and electronic document data are sent to document management server 1, which are saved in hard disk 13 of document management server 1, and registered with document management database 19.

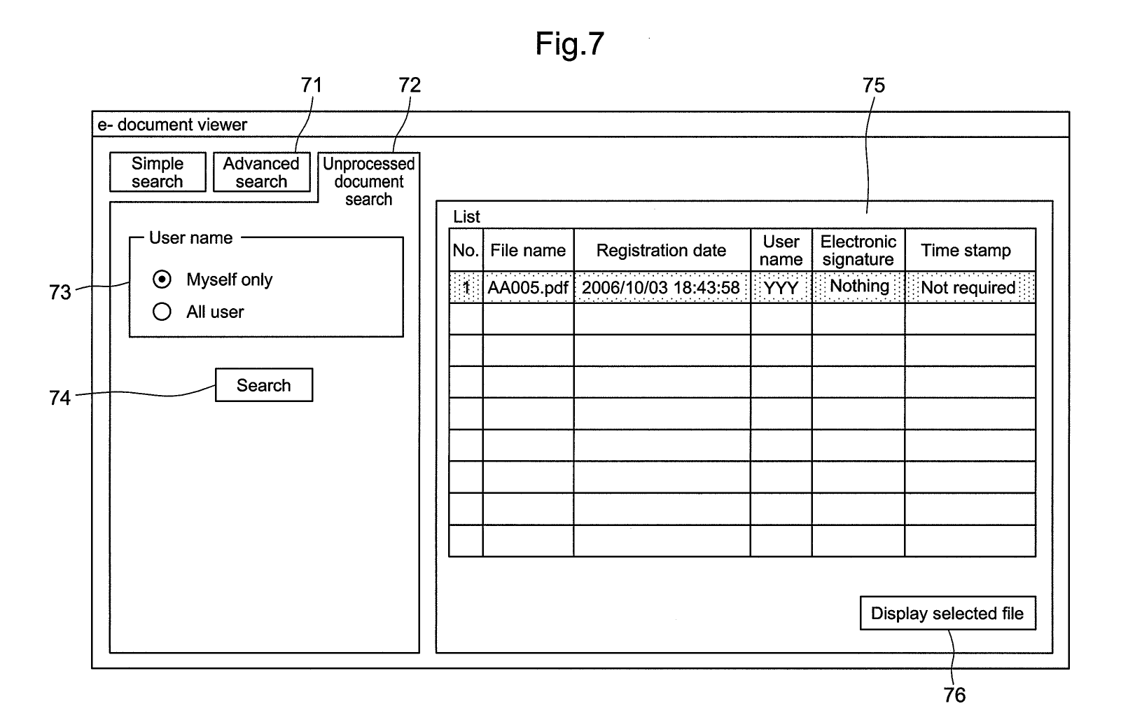

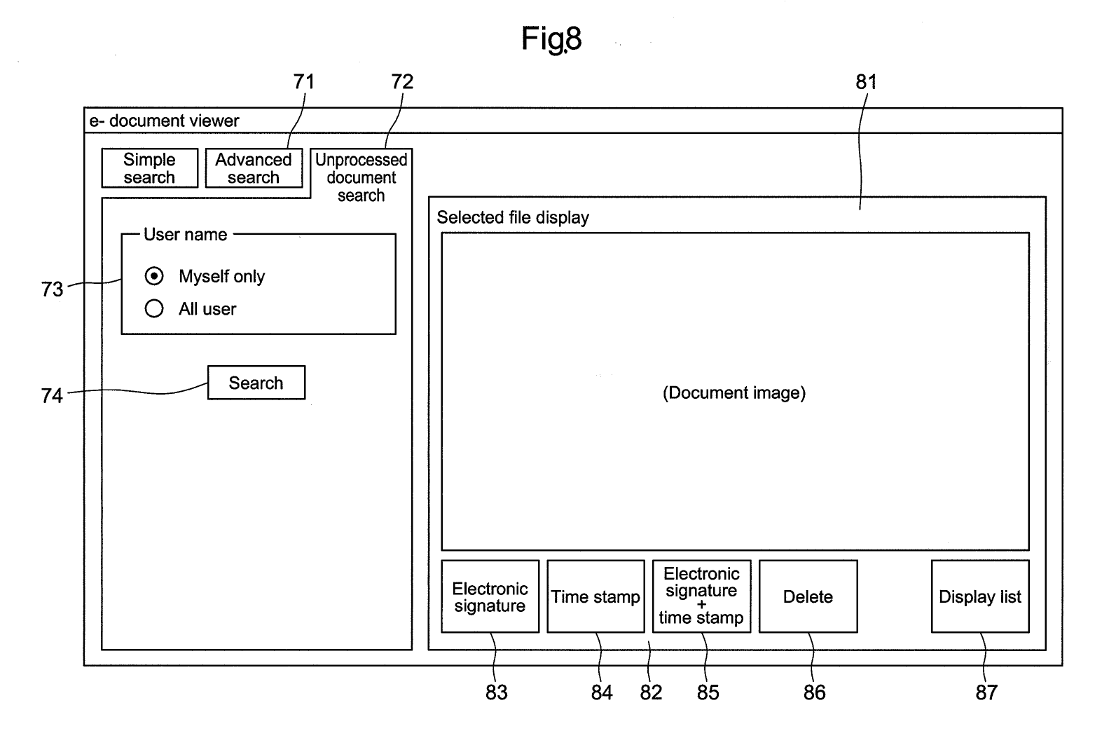

FIGS. 7 and 8 illustrate a document search screen displayed on CRT 33 of document management client 3 of FIG. 4. The document search screen can be displayed by starting an electronic document application at document management client 3, and by selecting a document search on an un-illustrated menu screen.

On a document search screen of FIG. 7, search method display selector 71 to select a search method is displayed. When button 72 of “unprocessed document search” that searches an unprocessed document is operated here, search condition selector 73 to select a search condition is displayed. When “myself only” is selected and search button 74 is operated, processing of searching a document with processing authorization by the user, in other words, a document the user has scanned via user authentication at multifunction apparatus 2, and an unprocessed document, or a document whose alteration prevention processing has not yet been performed even though it is specified as an alteration prevention process needed, is performed.

When a relevant document is found by the unprocessed document search, a file name, a registered date, a user name and its requirement and status of an electronic signature and a time stamp of the relevant document are displayed on list display selector 75. When a predetermined document is selected at list display selector 75 and button 76 of “selected file display” is operated, list display selector 75 switches to document display 81 as shown in FIG. 8 and a content of the document can be confirmed here.

On a document search screen of FIG. 8, processing method display selector 82 that allows a user to select an alteration prevention processing method and a document deletion is displayed. Here, each button of 83 through 86 is displayed and they are as follows: “electronic signature” that executes only an electronic signature; “time stamp” that executes only a time stamp; “electronic signature+time stamp” that executes both an electronic signature and a time stamp; and “delete” that deletes a document. After confirming a content of a document displayed on document display 81 and when there is no flaw, a predetermined alternation prevention is executed by operating one of the buttons 83 through 85 indicating “electronic signature”, “time stamp” or “electronic signature+time stamp”. Contrary, when there is a flow such as a missing page and the like, button 86 of “delete” is operated to delete the associated document and redo from scanning the original document.

In addition, on the document search screen, “display list” of button 87 is displayed. When the button 87 is operated, it returns to a document search screen of FIG. 7. By selecting another document here, it allows a user to confirm another document.

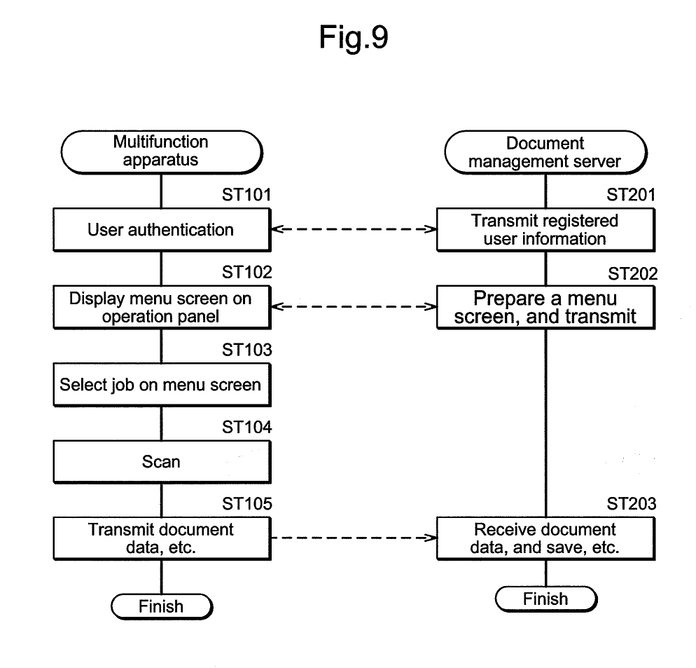

FIG. 9 is a flow chart that shows the document registration procedures performed at multifunction apparatus 2 and document management server 1 shown in FIG. 1. First, a user inputs a name and a password at multifunction apparatus 2, and then user authentication that confirms whether the user has authorization to use multifunction apparatus 2, is performed at user authentication 30 (step 101). At this time, document management server 1 transmits the user information retrieved by user manager 18 to multifunction apparatus 2 (step 201). The user authentication is performed at multifunction apparatus 2 based on the user information.

After the successful user authentication, when the user operates a predetermined button on operation panel 24, an request to prepare the screen associated with the button operation is sent to document management server 1. According to this, processing of generating a screen at operation panel manager 15 of document management server 1 is performed, and then the screen information is transmitted to multifunction apparatus 2 (step 202). At multifunction apparatus 2, predetermined screen is displayed on the display of operation panel 24 according to the display information obtained from document management server 1.

This enables to display a menu screen shown in FIG. 6 on a display of operation panel 24 of multifunction apparatus 2 (step 102). On this menu screen, a job selection operation is performed by a user (step 103). In response to the selected job, specified information with regard to alteration prevention, that is, whether to require an electronic signature and/or a time stamp, or neither is required, is generated.

Then, processing of scanning an image of the original document is performed (step 104), the obtained electronic document data, a user name obtained by the user authentication (step 101), and the specified information on alteration prevention obtained by the panel operation (step 103) are transmitted to document management server 1 (step 105). The electronic document data received at document management server 1 is saved in hard disk 13, and processing of registering the user name and specified information on alteration prevention with the document management database is performed at document management database 19 (step 203).

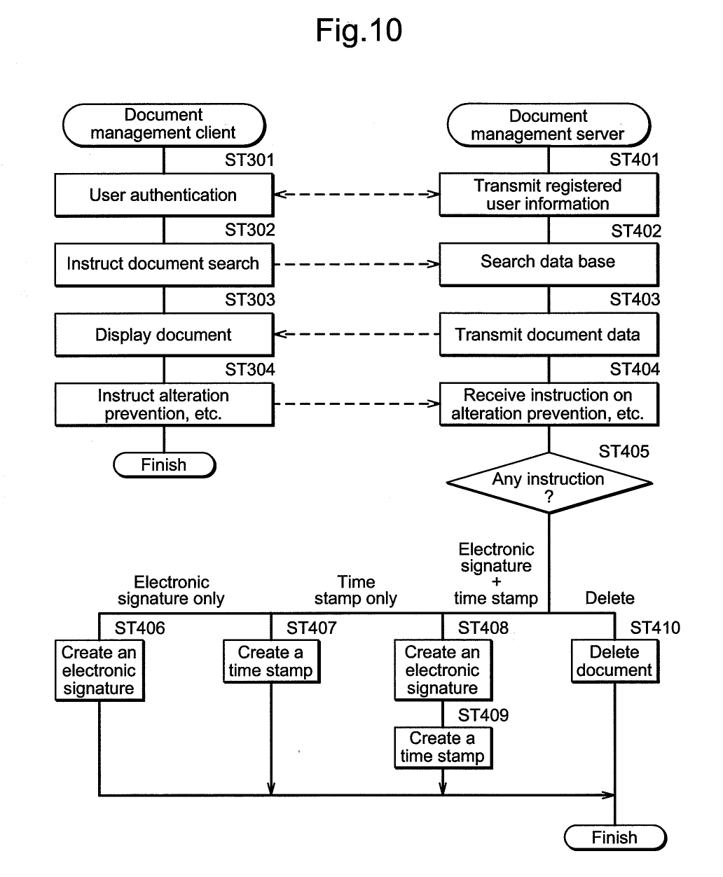

FIG. 10 is a flow chart showing the procedures for document confirmation and alteration prevention processing performed at document management client 3 and document management server 1 of FIG. 1. First, an application for electronic document is activated at document management client 3, and a user inputs a name and a password on the un-illustrated displayed user authentication screen for user authentication at user authenticator 39 (step 301). At this time, the user information retrieved by user manager 18 at document management server 1 is transmitted to multifunction apparatus 2 (step 401). The user authentication is performed at multifunction apparatus 2 based on the user information.

After the successful user authentication, the document search screen shown in FIG. 7 is displayed when the user performs a predetermined operation. When the user selects a predetermined search condition on the document search screen and instructs such a search (step 302), document search is performed at document management database 19 of document management server 1 based on the specified search condition (step 402). When a relevant document is found, such electronic document data or its thumbnail image data, which is the electronic document data reduced to the predetermined resolution, are transmitted to document management client 3 (step 403).

This enables to display the document image on document display 81 of the document search screen shown in FIG. 8 at document management client 3 (step 303). The user confirms whether there is a flow such as a missing page or a double scan, and then provides an instruction on a predetermined alteration prevention processing method and a deletion of the document. Concretely, when there are no flaws, the user operates buttons 83 through 85, which perform alteration prevention processing, and when there are any flaws, the user operates delete button 86 (step 304). Instruction information associated with the operated buttons 83 through 86 is transmitted to document management server 1.

When document server 1 receives instruction information from document management client 3 (step 404), according to the instruction information (step 405), processing of creating an electronic signature and a time stamp is performed at signature processor 16 and time stamp processor 17 (steps 406 through 409). When the instruction is to delete the document, processing of deleting the document from hard disk 13 and document management database 19 is performed (step 410).

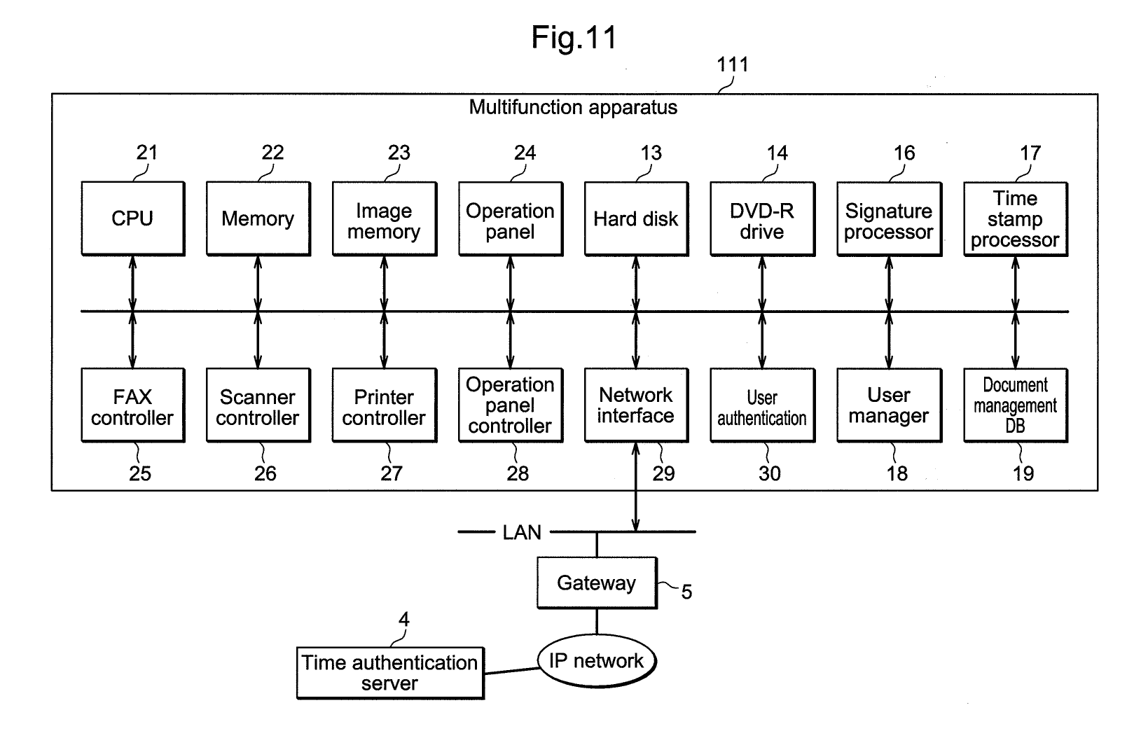

FIG. 11 is a block diagram showing another example of the document management system according to the present invention. Here, multifunction apparatus 111 includes, as same as multifunction apparatus 2 in the previous example: CPU 21; memory 22; image memory 23; operation panel 24; facsimile controller 25; scanner controller 26; printer controller 27; operation panel controller 28; network interface 29; and user authenticator 30.

Multifunction apparatus 111 includes the following components, which are provided in document management server 1 in the previous example: hard disk 13; DVD-R drive 14; signature processor 16; time stamp processor 17; user manager 18; and document management database 19.

Further, multifunction apparatus 111, the same as document management client 3 in the previous example, allows a user to view a content of the electronic document data and to confirm whether the electronic document data has any flaw. An image of the document is displayed on a display of operation panel 24, and the user can provide an instruction on an alteration prevention processing method and a deletion of the document by a button operation on operation panel 24.

In this configuration, the document management system is solely configured with multifunction apparatus 111, therefore, simplifying the system configuration can reduce the cost involved in document management.

In addition, in the previous example, a user is asked to input a user name and a password at the time of user authentication with user authenticator 30 of multifunction apparatus 2 and user authenticator 39 of document management client 3. However, it is not limited to such a user authentication method and it may be a configuration which identifies an operating user by scanning ID card owned by the user using a card reader. Further, a configuration which identifies an operating user by biometrics is also possible.

Further, in the previous example, an image of a document is scanned by image scanner (multifunction apparatus 2) to register with document management server 1. However, electronic document data to be registered with document management system server 1 are not limited to such electronic document data, and electronic document data made by a predetermined application at document management client 3 and electronic document data obtained from an outside source are also possible.

The document management system of the present invention is effective in avoiding unnecessarily increased expenses caused by an alteration prevention processing for electronic document data that are not in need of an alteration prevention or that include a flaw, and is useful as a document management system that manages a document by digitizing it.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2006-281510 filed on Oct. 16, 2006, entire content of which is expressly incorporated by reference herein.

What is claimed is:

1. A document management system comprising:
a memory that stores document data;
a document retriever that retrieves the document data from said memory;
a processor that executes alteration prevention processing for the document data;
a document confirmer that displays the document data retrieved by said document retriever, and issues an instruction whether to execute the alteration prevention processing; and
a controller that causes said processor to execute the alteration prevention processing when said document confirmer issues the instruction to execute the alteration prevention processing.

2. The document management system according to claim 1, further comprising:
an authorized user information memory that stores authorized user information, the authorized user information being associated with the document data; and
a user authentication controller that obtains user identification information from the user and determines whether the obtained user identification information is consistent with the authorized user information,
wherein said document retriever retrieves the document data being associated with the authorized user information when said user authentication controller determines the obtained user identification information consists with the authorized user information.

3. The document management system according to claim 1,
wherein the alteration preventing processing includes at least one of an electronic signature and a time stamp.

4. The document management system according to claim 1, further comprising:
a management information memory that stores management information, the management information indicating whether the document data needs the alteration prevention processing and whether the alteration prevention processing has been executed for the document data;
wherein the document retriever retrieves the document data when the management information indicates both that the document data needs the alteration prevention processing and that the alteration prevention processing has not been executed for the document data.

5. A document management system comprising:
a memory that stores document data;
an alteration prevention processor that executes alteration prevention processing for the document data;
an alteration prevention designator that specifies whether or not the document data requires the alteration prevention processing; and
a controller that prevents said alteration prevention processor from executing the alteration prevention processing when the alteration prevention designator specifies that the document data does not require the alteration prevention processing.

6. The document management system according to claim 5
wherein the alteration preventing processing includes at least one of an electronic signature and a time stamp.

7. The document management system according to claim 1, further comprising:
a server configured to include said memory, said processor, said document retriever and said controller; and
a terminal configured to include said document confirmer, said terminal being configured for connection with said server via a network.

8. The document management system according to claim 1, further comprising:
an image scanner that generates the document data and stores the document data in said memory.

9. The document management system according to claim 1, further comprising:
a data writer that saves the document data in said memory in an un-rewritable mass storage medium.
